(19) United States
(12) Patent Application Publication
(10) Pub. No.: US 2014/0295038 A1
(43) Pub. Date: Oct. 2, 2014

(54) METHOD FOR EXTENDING THE SHELF LIFE OF LIQUID COMESTIBLES

(71) Applicant: BNR Technology Development, LLC, Conroe, TX (US)

(72) Inventor: Jeffrey B. Norris, Montgomery, TX (US)

(73) Assignee: BNR Technology Development, LLC, Conroe, TX (US)

(21) Appl. No.: 14/219,099

(22) Filed: Mar. 19, 2014

Related U.S. Application Data
(60) Provisional application No. 61/805,650, filed on Mar. 27, 2013.

(51) Int. Cl. A23L 2/50

(52) U.S. Cl. CPC A23L 2/50
USPC 426/244

(57) ABSTRACT

The shelf life of a comestible liquid is prolonged by passing the liquid through an electrolytic cell. Electric current travels from one electrode to the other through the liquid. The electric current destroys bacteria present in the liquid. The current causes the osmotic balance of the bacteria cells to be disrupted causing the cell to either implode or explode.

This application claims the priority of U.S. provisional application Ser. No. 61/805,650 filed Mar. 27, 2013.

### BACKGROUND OF INVENTION

1. Field of the Invention

This invention relates to a method of treating liquid comestibles, for example, fruit juices, in order to improve their shelf life.

2. Description of Related Art

It is well know that fruit juices such as orange juice prepared for retail sales have a limited shelf life. The juice becomes darker in color and loses flavor due to, for example, oxide deterioration. So called “fresh orange juice” is prepared by extracting juice from oranges at harvest time and storing it in large vats. Typically, free oxygen in the juice is removed and the juice is pasteurized at temperatures about 185-201 degrees Fahrenheit. These treatments result in flavor loss such that flavoring is added to the juice after pasteurization. Different manufacturers prepare different “flavor packs” so that the flavor varies from brand to brand. One prior art solution to this problem is to deoxidize the comestible by generating hydrogen in an electrolytic cell that has a permeable membrane separating the anode and cathode sections from each other. The anode compartment contains a highly dissociatable, non-oxidizable inorganic acid electrolyte. When the cell is connected to a suitable source of electric power, hydrogen is formed at the cathode to remove the oxygen from the juice. See U.S. Pat. No. 4,374,714 to Hebral, granted Feb. 22, 1983, the entire contents of which is incorporated herein by reference.

Another approach is taught by the U.S. Pat. No. 4,857,343 to Herbral issued Aug. 15, 1989. This patent teaches the concept of lowering the pasteurization temperature required for orange juice by lowering the pH of the fruit juice. The high temperature of pasteurization causes carmelization or darkening of the juice which is undesirable.

Pasteurization destroys bacteria and bacterial enzymes which promote bacterial growth. Bacteria and bacterial enzymes are believed to contribute to the discoloring of the liquid and the sour taste associated with aging liquid comestibles such as milk and fruit juices. Pasteurization also inactivates certain enzymes which causes the pulp to separate from the juice. This process has also been found to deter the tendency of pulp in orange juice from increasing in density as it ages.

### BRIEF SUMMARY OF THE INVENTION

The present invention prolongs the shelf life of fruit juices such as orange juice by destroying bacteria and possibly the bacterial enzymes by subjecting the juice to an electrical current.

Electrical current has been found to be effective in killing bacteria. See for example, U.S. Pat. No. 5,922,209 to Yoshida et al granted Jul. 13, 1999 and U.S. Pat. No. 5,948,273 to Yoshida et al granted Sep. 7, 1999. The phenomenon is also discussed in “Effects of Micro Amperage, Medium and Bacterial Concentration on Ionlophoretic Killing of Bacteria in Fluid,” C P Davis et al, Department of Microbiology, University of Texas, Medical Branch, Galveston, Antimicrobial Agent and Chemotherapy, April 1989, pages 442-447.

The juice to be treated is introduced into an electrolytic cell where electrical current within the cell destroys the bacteria in the juice.

### BRIEF DESCRIPTION OF THE SEVERAL VIEWS OF THE DRAWING(S)

FIG. 1 illustrates an embodiment of a fluid processing system suitable for carrying out an embodiment of the method according to the invention.

### DETAILED DESCRIPTION OF THE INVENTION

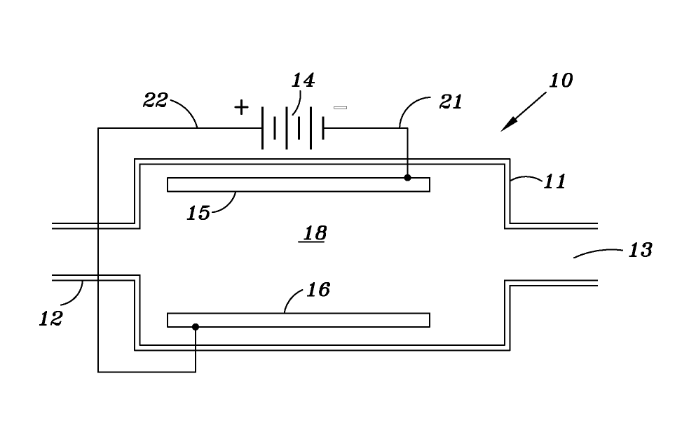

Referring to FIG. 1, the method according to an embodiment of the invention can be practiced as follows. The comestible fluid to be treated is introduced through an inlet 12 into an electrolytic cell 10 which includes a housing 11 which has an interior chamber 18. A pair of electrodes 15 and 16 are located within the housing and are connected to a source of power 14 via wires 21 and 22 or the like. Power source 14 is preferable a direct current power source.

In order to prevent damage to the good components of the juice, the current should be kept to the minimum amount necessary to kill the bacteria without adversely affecting the other components. It is also desirable to use noble electrodes to avoid releasing metallic ions into the juices. The use of inert electrodes made of a thin titanium plate coated with a ruthenium coating performed extremely well. They stopped the release of ions in the juice while allowing sufficient current to only destroy the bacteria.

Treated juice is removed from the cell via outlet 13 for further handling. Inlet 12 and outlet 13 may contain valves so that the liquid is either batch treated or treated as a continuous flow passing through the cell.

The size of the inlet, outlet and reservoir 18 is chosen so as to allow a sufficient residence time to destroy the bacteria and enzymes.

Direct current is utilized providing between 0.01 amps and 0.5 amps per square inch through the juice.

A test using fresh squeezed orange juice was conducted using an electrolytic cell with 2 titanium electrodes with a ruthenium coating spaced ¼″ apart. The electrodes were 4 inches wide and 6 inches long. The total volume of the cell was approximately one quart. The test protocol was to test different batches of juice utilizing different current densities and varied residence times. The purpose of the test is to do a visual examination of the samples at 90 day intervals looking for color changes, signs of bacteria growth or a difference in the volume of pulp settling on the bottom of the sample container. Since color is one of the primary indicators that the orange juice has lost its freshness and therefore not marketable, color changes were the primary indicator for freshness for this testing. The current densities and residence times for the samples are listed below along with the observed color changes at 90 day intervals. Current density is defined as amperage per square inch of the electrode area.

| | | DAYS | |
|---|---|---|---|
| | | 90 | 180 |
| Sample 1: | Residence time: 10 seconds * | Good | Poor |
| current density -.01 | | | |
| Sample 2: | Residence time: 10 seconds * | Good | Good |
| current density -.03 | | | |
| Sample 3: | Residence time: 10 seconds * | Poor | Poor |
| current density -.05 | | | |
| Sample 4: | Residence time: 10 seconds * | Poor | Poor |
| current density -.07 | | | |
| Sample 5: | Residence time: 30 seconds * | Good | Poor |
| current density -.01 | | | |
| Sample 6: | Residence time: 30 seconds * | Good | Good |
| current density -.04 | | | |
| Sample 7: | Residence time: 30 seconds * | Poor | Poor |
| current density -.06 | | | |
| Sample 8: | Residence time: 30 seconds * | Poor | Poor |
| current density -.08 | | | |

Definition good: Shows no significant color change, no bacterial growth, pulp maintains volume.

Definition poor: Shows visible color change, usually darker color. May or may not show some bacterial growth and usually shows a change in volume of pulp settling on bottom of sample container.

Test results proved that using the correct current density and the correct residence time can result in the juice maintaining color and pulp density.

Although the present invention has been described with respect to specific details, it is not intended that such details should be regarded as limitations on the scope of the invention, except to the extent that they are included in the accompanying claims.

I claim:

1. A method of prolonging the shelf life of a comestible liquid comprising:
providing an electrolytic cell having a pair of electrodes, an inlet for the liquid, an outlet for the liquid and a power source;
introducing the liquid to be treated into cell via the inlet;
energizing the pair of electrodes so as to cause current to pass from a first electrode to a second electrode; and
removing the liquid to be treated from the cell via the outlet.

2. The method of claim 1 wherein the electrolytic cell includes a plurality of pairs of electrodes.

3. The method of claim 1 wherein the comestible liquid is continuously introduced to and withdrawn from the electrolytic cell.

4. The method of claim 1 wherein the comestible liquid is held in the electrolytic cell for a given period of time and then removed.

5. The method of claim 1 wherein the liquid to be treated is orange juice, grape and other fruit juices.

6. The method of claim 1 wherein the electrodes are a titanium plate with a ruthenium coating or other similar noble coatings.

7. The method of claim 1 wherein a direct current power source is utilized to energize the electrodes which provides a current density between 0.01 amps and 0.5 amps per square inch depending on the type of juice treated.

8. The method of claim 1 wherein the comestible liquid resides in the electrolytic cell for 5 to 60 seconds.
